(19) United States
(12) Patent Application Publication
(10) Pub. No.: US 2015/0083027 A1
(43) Pub. Date: Mar. 26, 2015

(54) Stand Up Desk Having Adjustable Telescoping Legs

(71) Applicant: Dayna Adrienne Martin, Vienna, VA (US)

(72) Inventor: Dayna Adrienne Martin, Vienna, VA (US)

(21) Appl. No.: 14/033,566

(22) Filed: Sep. 23, 2013

(51) Int. Cl. F16M 11/32

(52) U.S. Cl. CPC F16M 11/32
USPC 108/1; 108/147.21

(57) ABSTRACT

A stand up desk having adjustable telescoping tube legs. The legs offer a wide range of height adjustments and create a strong and stable base for a desktop of the stand up desk offering the user better health benefits and an ergonomic work environment. A base system for the desktop is further disclosed offering a five point anchoring system giving the desktop more stability.

This application claims priority to U.S. Provisional patent application Ser. No. 61/720212 filed Oct. 30, 2012. The foregoing application is hereby incorporated by reference in its entirety as if fully set forth herein.

### FIELD OF THE INVENTION

This disclosure is generally directed to a stand up desk that improves health and provides a user to work ergonomically standing up.

### SUMMARY OF THE INVENTION

Sitting for long periods of time negatively impacts quality of life for many people. Poor posture and existing back injuries can make sitting painful, and recent studies have shown that sitting most of the day decreases human lifespan by two to three years.

The majority of standing desks require the customer to replace their current desk. Many customers are unwilling to do this, especially if they work in a cubicle where removing the desk is not an option.

Existing desktop stand up desks do not offer a sufficient range of height adjustments to be ergonomic for the majority of the population, and several are not adjustable at all.

Existing standing desks are also prohibitively expensive for most of population, leaving the health benefits of standing out of their reach.

These legs will be used to create a standing desk that sits on top of the customer's current desk, adjusts to their correct ergonomic height, and is strong, stable, and affordable.

As stated above, sitting for long periods of time negatively impacts quality of life for many people. Poor posture and existing back injuries can make sitting painful, and recent studies have shown that sitting most of the day decreases human lifespan by two to three years. The invention claimed here solves this problem.

These legs will be used to create an adjustable standing desk that is designed to sit on top of the customer's existing desk or table. They will adjust it to their proper ergonomic height, enabling them to work standing up and therein eliminating the negative effects of working sitting down. Furthermore, the standing desk can be made tiltable using the telescoping legs.

The invention differs from what currently exists. No known desktop standing desk currently uses telescoping tubes to adjust its desktop. The invention further uses a five-point anchoring system to better stabilize the desktop from lateral forces.

This invention is an improvement on what currently exists. The invention differs from what currently exists. The majority of standing desks on the market require the customer to replace their entire desk. These legs allow for the creation of a stand up desk that sits on top of the customer's desk, so they do not need to replace the desk they already have. These legs allow have a wider height adjustment range than other products on the market, allowing customers of more varied heights to be able to work ergonomically standing up. The majority of standup desks are prohibitively expensive. These legs will allow the standing desk to be sold at a lower price point than other desk top stand up desks on the market, allowing more people to take advantage of the health benefits of standing.

### BRIEF DESCRIPTION OF THE DRAWINGS

FIG. 1 shows an isometric view of the stand up desk being used on top of an ordinary desk and a person utilizing a computer set on top of desktop of the stand up desk.

FIG. 2 shows an isometric view of the stand up desk of the instant invention.

FIG. 3 shows an exploded view of the stand up desk shown in FIG. 2.

FIG. 4 shows a cross-sectional view of section 4-4 of the stand up desk shown in FIG. 2.

FIG. 5 shows a close-up view shown in FIG. 4 showing the intersection of two U-shaped members and an anchoring point.

FIG. 6 shows a cross-sectional view of the telescoping legs at a fixed position.

FIG. 7 shows a cross-sectional view of the telescoping legs being disengaged from each other.

FIG. 8 shows a cross-sectional view of the telescoping legs being engaged with each other at a different fixed position than that shown in FIG. 6.

FIG. 9 shows an isometric view of the stand up desk being tilted.

FIG. 10 shows a side view of the stand up desk being tilted.

### DETAIL DESCRIPTION OF THE DRAWINGS

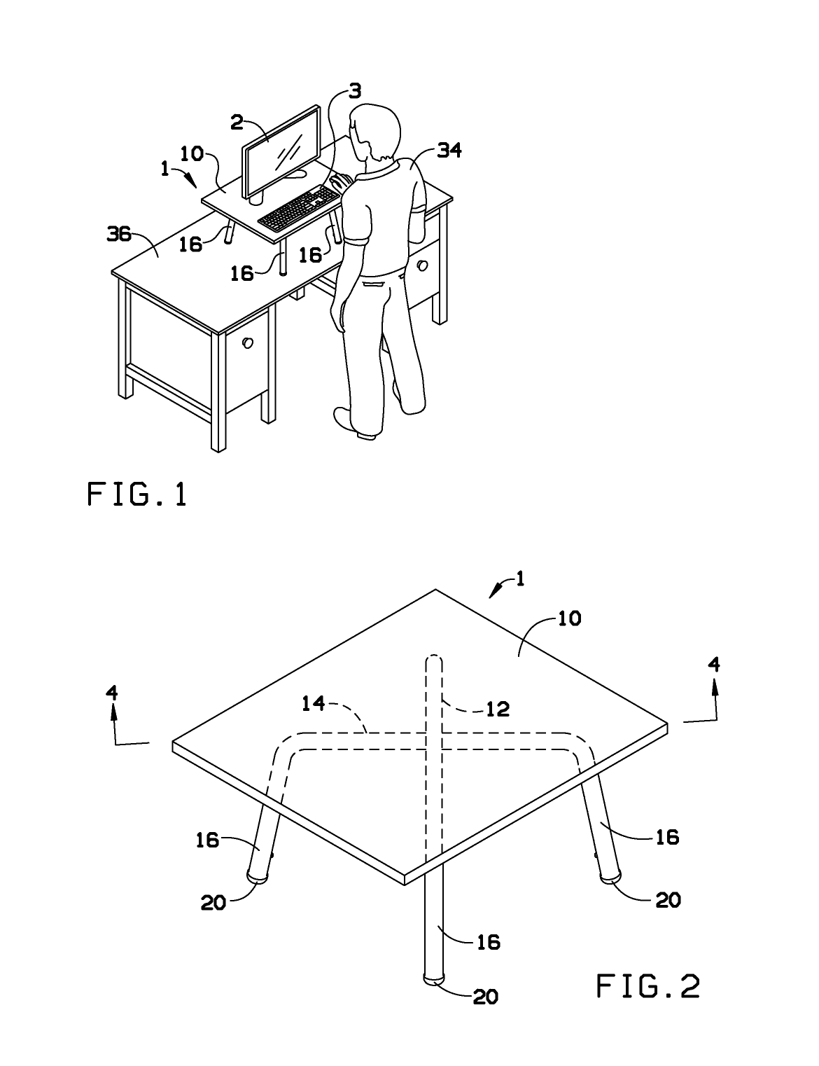

FIG. 1 shows a setup where the stand up desk 1 is set on top of an ordinary desk 36. The desktop 10 of the stand up desk 1 holds a computer screen 2 and a keyboard 3. The stand up desk 1 has outer telescoping legs 16 that allow a user 34 to level the desktop 10 to a proper height thus making an ergonomic environment and adjustable.

FIG. 2 shows the stand up desk 1 including a first U-shaped member 12 and a second U-shaped member 14 both upside down that provide both a support to a desktop 10 as well contain outer telescoping legs 16. Each of the outer telescoping legs 16 are plugged with feet 20 thus preventing the ordinary desk 36 from being scratched.

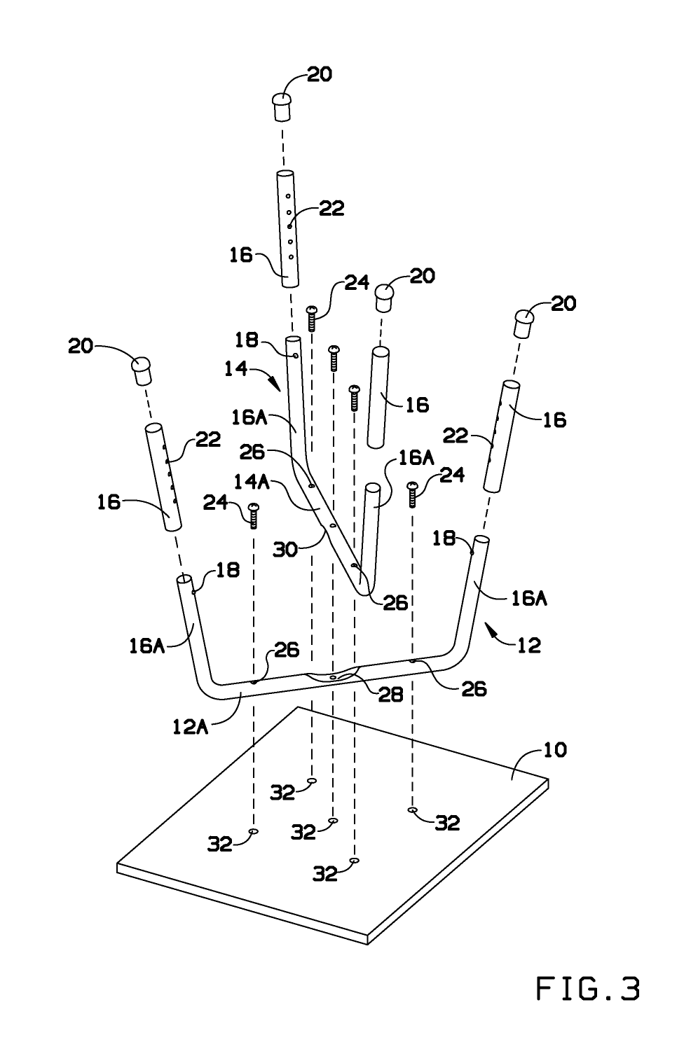

FIG. 3 shows the stand up desk 1 in an exploded view and in upside-down orientation. The U-shaped members 12, 14 are tubular in shape, and the U-shaped members 12, 14 are respectively comprised of a horizontal member 12a, 14a. The horizontal members 12a, 14a have a pair of inner telescoping legs 16a at opposite ends of the horizontal legs 12a, 14a. The inner telescoping legs 16a are angled relative to the horizontal members 12a, 14a to provide the stand up desk stability from external lateral forces. The horizontal members 12a, 14a comprises opposite anchoring holes 26 which fasteners 24 pass through to anchor the U-shaped members 12, 14 to the desktop 10 and be fastened to threaded inserts 32 embedded on the desktop 10 either by gluing, pressed fitted, or threaded therein. The U-shaped members 12, 14 further include outer telescoping legs 16 with adjustable holes 22 positioned longitudinally to the outer telescoping legs 16. The adjustable holes 22 are able to receive the button locking pins 18 that project from the inner telescoping legs 16a so the desktop 10 can be adjusted to any ergonomic height level.

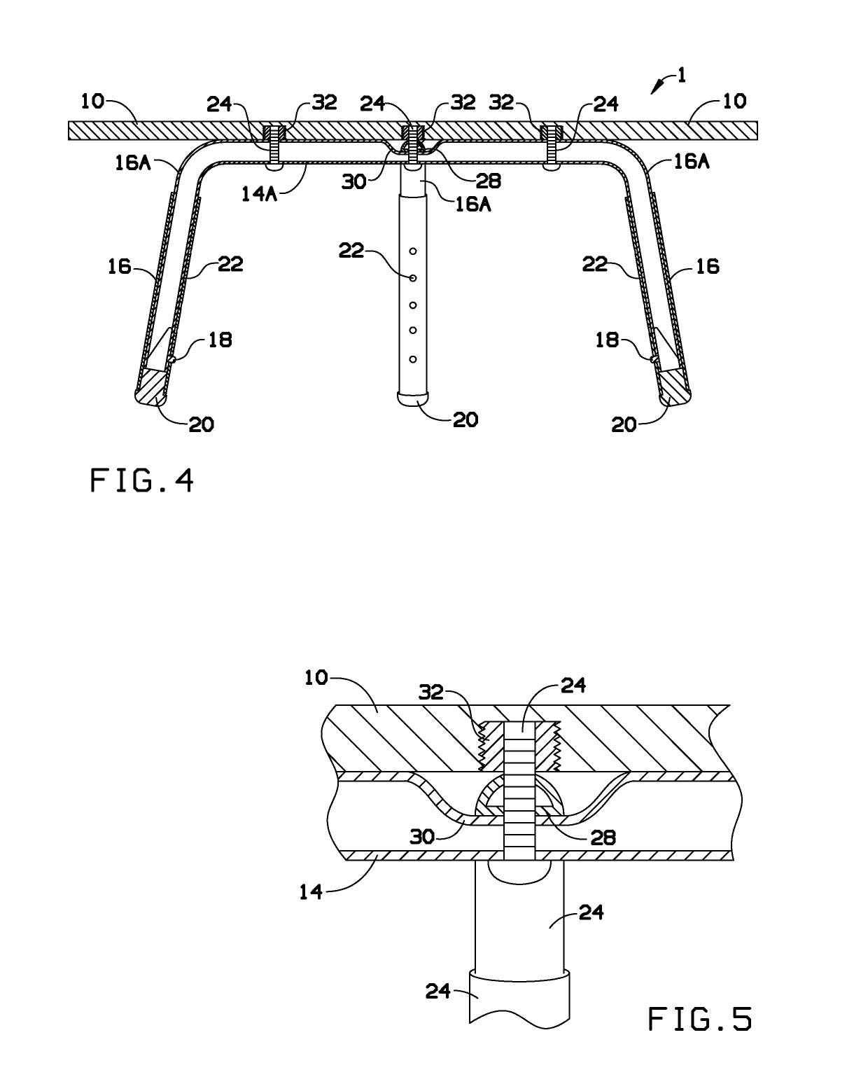

As seen in FIGS. 3-5, the U-shaped members 12, 14 respectively includes a notch 28, 30 that face each other and mate with each other to make the U-shaped members 12, 14 crisscross with each other. The first notch 28 and the second notch 30 contain a through hole 36 that allows a fastener 24 to pass through providing a fifth anchoring point on a threaded insert 32 embedded in the desktop 10. Of course, while there's mention of five anchoring points, it is envisioned that the U-shaped members 12, 14 can be fastened to the desktop 10 with just the through holes 36 and one threaded insert 32 thus using one anchoring point dead center to the desktop 10. Of course, for better stability, five anchoring points or four anchoring points are also envisioned. Evidently, the five anchoring points is the superior system as the stand up desk withstands greater lateral forces. The first notch 28 and the second notch 30 can either be made by pressing, crushing, cutting, or milling a center portion of the horizontal members 12a, 14a so that the first notch 28 faces the second notch 30 and nest with each other. In other words, the crushed section creates a bridge diving the horizontal members 12a, 14a into two sections and used as the fifth anchoring point.

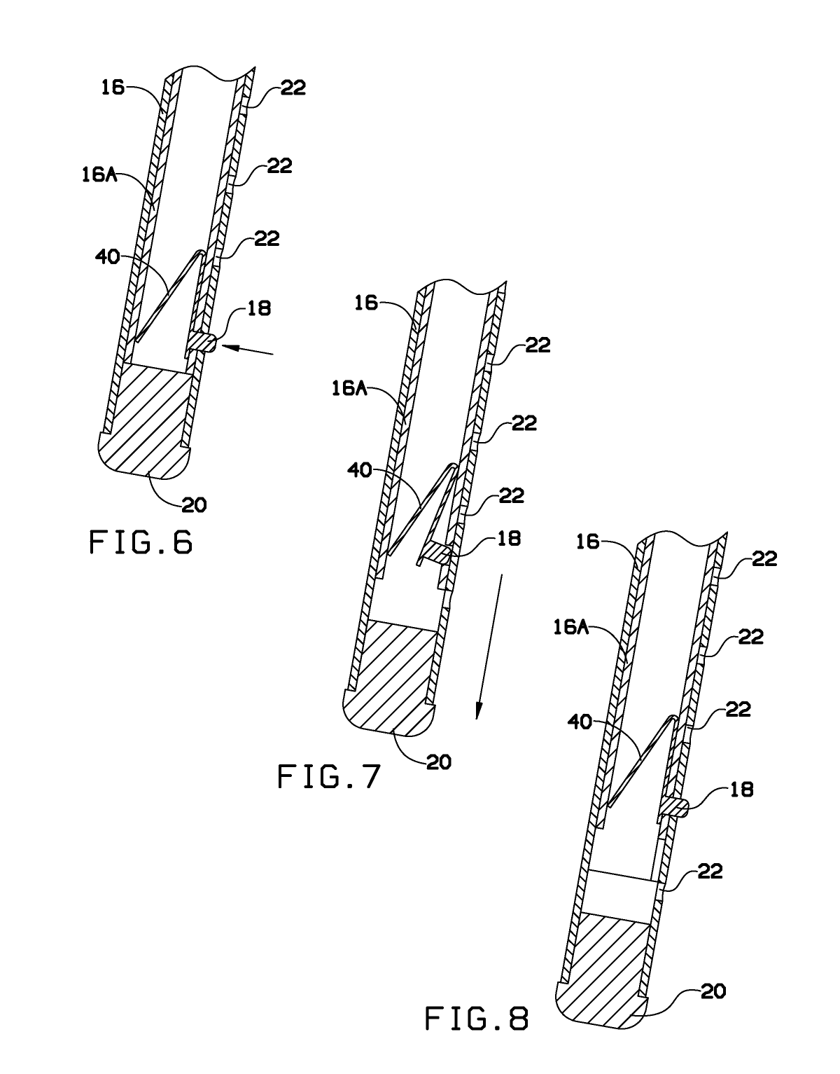

As shown in FIGS. 6-8, the outer telescoping leg 16 is a tubular member 16 and the inner telescoping leg 16a slides along several positions via button locking pins 18 that flex in and out of the inner telescoping leg via a v-shaped leaf spring 40. When a user wants to adjust one of the outer telescoping legs 16, the user merely pushes in the locking pin 18 until the pin 18 disengages the engagement hole 22 thus freeing the outer telescoping leg 16 to be positioned at any desired hole for adjusting the ergonomic height of the desktop 10.

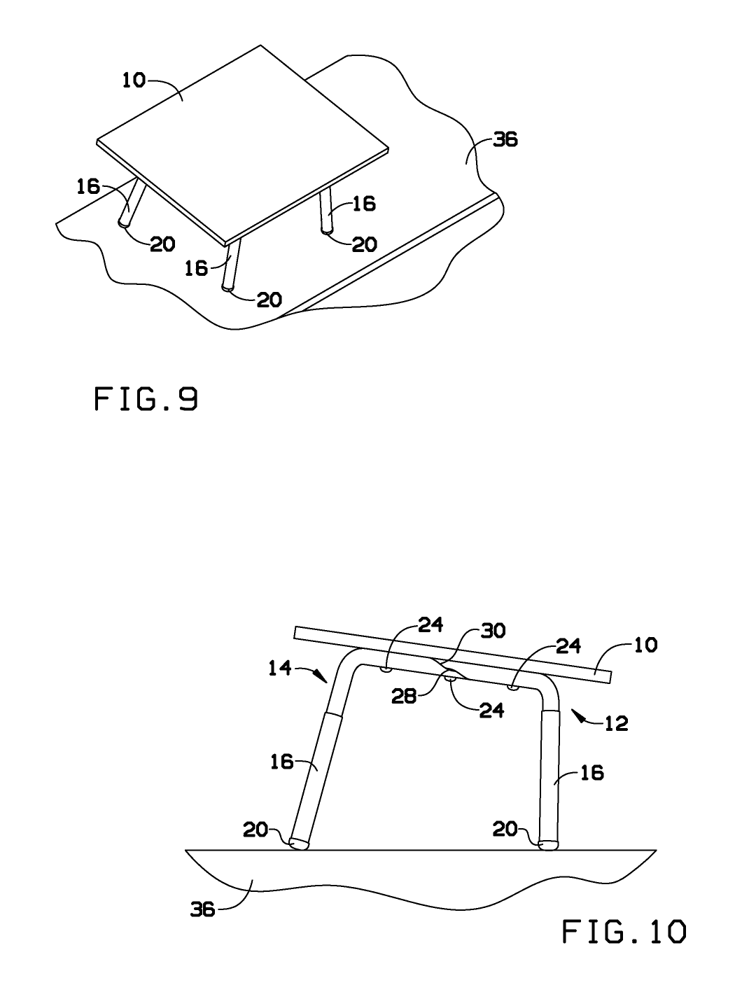

It is envisioned that the U-shaped members 12, 14, which are tubular as shown, could as well be solid members. The design of the components could be altered, but it would still serve the same core function. Changes that could be made but would not alter function include: the shape of the desktop 10, the angle of the bends of the inner telescoping legs 16a relative to the horizontal members 12a, 14a, the length of the U-shaped members 14, 16, the tube material, the tube color or finish, the adjustment hole size 22, the number of adjustment holes 22, the locking pin size, and the locking pin type. It is also envisioned that the outer telescoping leg 16 can be made as an inner telescoping leg so that it fits inside the telescoping leg 16a. Further, it is envisioned that the holes and the locking pins can be replaced with a twist and lock mechanism, not shown, to adjust the outer telescoping leg 16. It is also envisioned that the stand up desk can be sold unassembled and will only take a few minutes to assemble. Two of the outer telescoping legs 16 can telescope more outward than the other two of the outer telescoping legs 16 in the opposite side such that the desktop 10 is tiltable towards the user 34 as shown in FIGS. 9 and 10. It is envisionsed that desktop 10 can also tilt away from the user 34.

While there's no specific reference to the materials used beforehand. It is envisioned that the U-shaped members 12, 14 can be made of metal or any other material. The feet 20 can be made from plastic, rubber, or any known material, and the desktop 10 can be made of any material, especially wood or similar to any common desktop.

1. A stand up desk comprising a desktop and a pair of upside down U-shaped members crisscrossed with each other and supporting the desktop both along a plane.

2. The stand up desk of claim 1, further comprising at least one fastener passing through a fastening hole at the intersection of the U-shaped members fastening to the desktop.

3. The stand up desk of claim 2, wherein the U-shaped members are tubular members comprising each a horizontal member and a pair of inner telescoping legs.

4. The stand up desk of claim 3, wherein each of the U-shaped members further includes a pair of outer telescoping legs each adjustable relative to the inner telescoping legs and respectively fastened to the inner telescoping legs with a button locking pin passing through the inner telescoping legs and at least one of a series of adjustment holes in the outer telescoping legs.

5. The stand up desk of claim 4, wherein the button locking pin further includes a leaf spring housed in the inner telescoping legs.

6. The stand up desk of claim 3, wherein each of the inner telescoping legs are angled relative to the horizontal member at more than 90 degrees.

7. The stand up desk of claim 3, wherein each of the horizontal members comprises a notch in a middle portion of the horizontal member forming a bridge;
the notch of one of the horizontal members faces the notch of the other horizontal members nesting the U-shaped members along the plane; and,
wherein the at least one fastener passes through both the notches anchoring the U-shaped members to the desktop.

8. The stand up desk of claim 4, wherein each of the outer telescoping legs includes feet plugging one end of the outer telescoping legs.

9. The stand up desk of claim 7, wherein each of the horizontal members further includes opposite fastening holes forming with the fastener at the intersection five anchoring points; and wherein four additional fasteners respectively pass through the opposite fastening holes.

10. The stand up desk of claim 9, wherein each of the fasteners are threaded in an insert fastened to the desktop.

11. The stand up desk of claim 4, wherein the outer telescoping legs are of the same length and two of outer telescoping legs are telescoped longer than the other two outer telescoping legs thus tilting the desktop.

12. The stand up desk of claim 3, wherein each of the horizontal members further includes opposite fastening holes; and wherein at least four fasteners respectively pass through the opposite fastening holes connecting to the desktop.
